(19) United States
(12) Patent Application Publication
(10) Pub. No.: US 2015/0302099 A1
(43) Pub. Date: Oct. 22, 2015

(54) Automated Recommendations Based On Historic Location-Preference Information

(71) Applicant: Yahoo! Inc., Sunnyvale, CA (US)

(72) Inventors: Bharathi Shekar, Bangalore (IN); Ashootosh Chand, Bangalore (IN); Arnab Nandi, Bangalore (IN)

(21) Appl. No.: 14/755,037

(22) Filed: Jun. 30, 2015

Related U.S. Application Data
(63) Continuation of application No. 13/550,703, filed on Jul. 17, 2012.

(51) Int. Cl. G06F 17/30; H04L 29/06

(52) U.S. Cl. CPC G06F 17/30867; G06F 17/30241; G06F 17/3053; H04L 65/403

(57) ABSTRACT

Techniques are described for providing automated recommendations of real-world locations, such as businesses, for users to visit based at least in part on historical location-preference information. The historical location-preference information used by the recommendation system may include the historical location-preference information of the person that requests the recommendation, other people explicitly identified as participants by the requestor, and/or other people implicitly determined to be participants. The historical location-preference information may be explicit, such as “check-ins” or reviews, or implicit. Implicit participants may be identified in a variety of ways, including social network relationships and the context in which the recommendation request is submitted.

This application is a Continuation of prior U.S. patent application Ser. No. 13/550,703 (Attorney Docket No. 50269-1468) entitled “Automated Recommendations Based On Historic Location-Preference Information”, filed Jul. 17, 2012, the contents of which are incorporated herein by reference for all purposes.

### FIELD OF THE INVENTION

The present invention relates generally to automated recommendations and, in particular, to automated recommendations that take into account historic location-preference information.

### BACKGROUND

It has become common for users to turn to automated services for recommendations. For example, myriad online sites provide recommendations for places to eat, movies to watch, even people to date. Often, users want recommendations for real-world locations they would like to visit for a particular purpose. For example, a user may want to find the nearest bank to withdraw money, or the nearest restaurant to eat. When formulating a recommendation for such situations, an automated recommendation service may assume that the user is currently located at a default location, or may ask for the user to specify the user's current location. If the user is submitting the request using a location-aware device, the automated recommendation service may simply obtain the user's current location from location data automatically provided by the device. However obtained, the system will typically use the current location of the requestor as a basis for selecting which real-world location to recommend.

Unfortunately, there are many circumstances where the business closest to a user's current position does not best suit the user's needs. For example, if three people are planning to meet for lunch, the restaurant closest to the current position of the person who happens to ask for the recommendation is not necessarily the best choice, because it may require excessive travelling on the part of the other two recipients. This is merely one example of how an automated recommendation service's over-reliance on current location data may lead to less-than-optimal recommendations.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram of a map with indicators that may be generated according to an embodiment of the invention;

FIG. 2 is a block diagram of the map illustrated in FIG. 1, in which visual indicators are provided for recommendations that take into account historical location-preference information, according to an embodiment of the invention; and

FIG. 3 is a block diagram upon which embodiments of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are described herein for providing automated recommendations of real-world locations, such as businesses, for users to visit based at least in part on historical location-preference information. The historical location-preference information used by the recommendation system may include the historical location-preference information of the person that requests the recommendation (the “requestor”), other people explicitly identified as participants by the requestor, and/or other people implicitly determined to be participants. Various techniques for determining participants shall be described in greater detail below.

The historical location-preference information used by the recommendation system is not about where the participants currently reside, but rather information about real-world locations about which the participants have previously expressed an interest. The prior expressions of interest may have been explicit (e.g. a review of or “check in” at a restaurant) or implicit (e.g. photos taken at the restaurant, visits to the web page of the restaurant, etc.).

Based on the historical location-preference information, an automated recommendation system may recommend a real-world location that better suits the requestor's needs than the real-world location closest to the requestor's current location. For example, based on historical location-preference information, the automated recommendation system may recommend a restaurant, in the general vicinity of the participants, that has been most frequently visited by the participants in the past. Historical location-preference information may be one of many factors used in the automated recommendation selection. Other factors that may be used in combination with the historical location-preference information include, but are not limited to, the current location of the participants, demographic information about the participants, search terms, traffic conditions, etc.

### Business Listing Search Services

As mentioned above, requestors are often looking for places to socialize while using business listings search services. For example, one question to answer is: “Which is the best place for me to have lunch with my friends today?” As noted above, services that optimize recommendations based on the requestor's current distance to business listing will often provide non-optimal recommendations to such queries. Specifically, the business listing nearest to an individual may not be optimal for the intended participants as a whole.

To optimize business listings search results, a business listing service may use the techniques described, thereby taking into account locations-preference information when providing search results. The location-preference information may, for example, have been declared by a group of friends in the past. There are any number of sources from which the business listing service may obtain such locations-preference information. For example, many applications, both mobile based and browser based, allow users to check-in to a place. By checking-in, a user shares the user's current location (point on the globe where the user is present at that time) to the user's friends. By leveraging this information, obtained over a period of time, a business listing service may identify the location-preference information of individuals and then recommend the most optimal business listing for a social circle as a whole. The business listings most frequented by the individuals of a social circle will be recommended.

### Business Listing Example

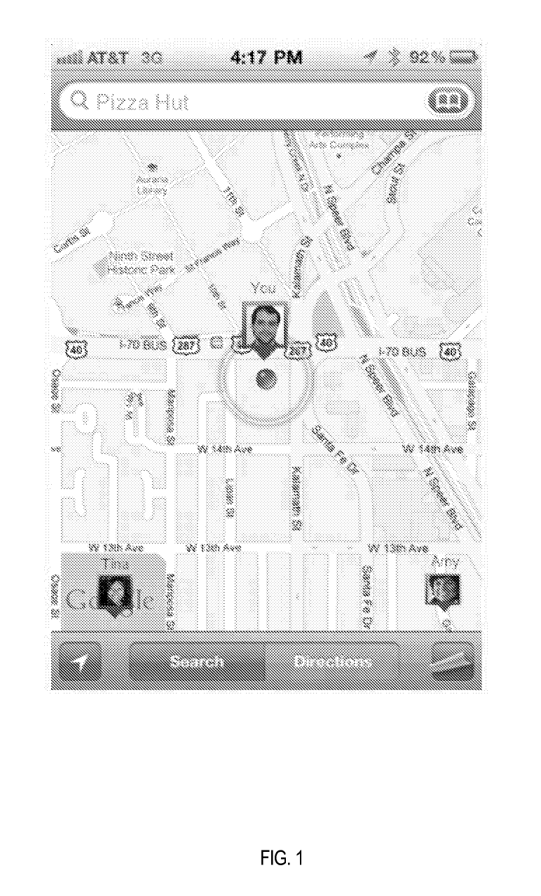

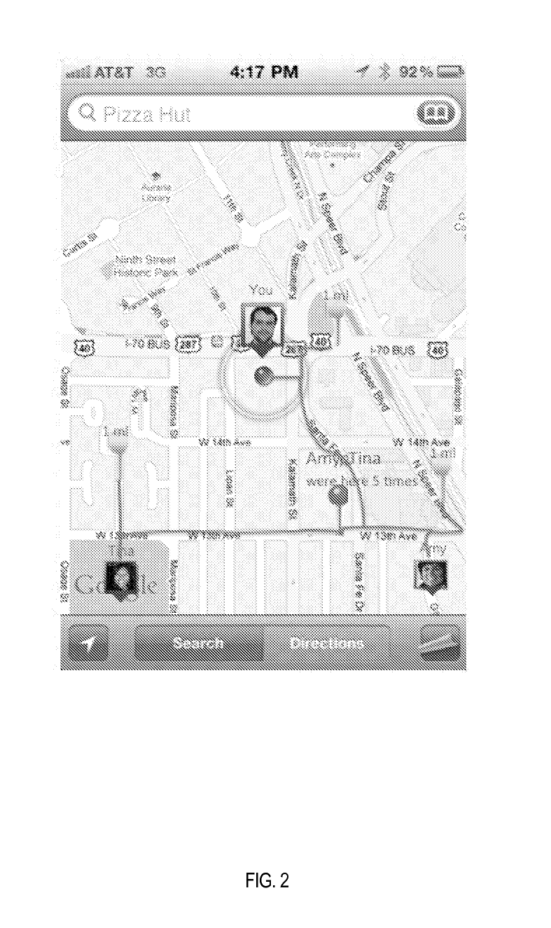

An example of how a business listing service may make use of historical location-preference information shall now be provided with reference to FIGS. 1 and 2. In this example, the business listing service recommends in the search results business listings (a) that fall within a bounding box of the user's current location and (b) where individuals of the social circle were known to be present in the past. In this case, the user might want to hang out with his friends at the location that is most frequented by them. In the present example, the historical shared locations of all the users in a particular social circle will be taken into account for generating the recommendation.

Referring to FIG. 1, it illustrates a map that shows the current location of three friends: “Tom”, “Tina” and “Amy”. For the purpose of explanation, it shall be assumed that the three friends want to have lunch together. Each one of them is carrying a smart phone and part of a smart-phone-based social networking application. Each one of them is working in a different part of the city at the time they want to meet. Specifically, Tom, Tina and Amy are all in New York city, but in different areas, separated by at least 5 miles from each other, but they want to meet up and have pizza together. In this case, the locations of interest are the current locations of Tom, Tina and Amy in New York City.

FIG. 1 illustrates where Tom, Tina and Amy are currently located when Tom initiates a search for business listings relating to pizza. In FIG. 1, Tom's, Tina's and Amy's current locations have been plotted on a single map view along with their photographs. Tom has entered “Pizza Hut” as the business listing search keyword.

FIG. 2 illustrates the search results after Tom clicked “Search”. Referring to FIG. 2, the search results (i.e. Pizza Huts) are marked with pins. Only the most optimal search results, based on distance, are shown. In the example illustrated in FIG. 2, the business listings closest to each of Tom, Tina and Amy are indicated with pins of a certain color (e.g. green) and marked with distances from their points of reference. On the other hand, the business listing that was most frequented by the members of the social circle is indicated with a pin of a different color (e.g. pink). A message (which may also be in pink) indicates the members who visited the place in the past. This is the recommended business listing.

In this example, the business listing search service takes into account a variety of factors in formulating its recommendations. Those factors include:

The participants' current locations. Based on the current locations, the business listing service establishes a maximum radius: A bounding box of 10 Kms within which business listings [Pizza Hut] will be searched.

Location information from the past: The business listing service may pick up, for example, the historical location-preference information of users up to three months prior to the time of search.

Traffic conditions: For example, the known time, according to traffic conditions at the time of search, to travel for the user should be within 15 minutes.

These are merely a few examples of factors that may be used by a business listing search service in formulating a recommendation. There is virtually no limited to the number of factors that may be used in conjunction with historical location-preference information, to formulate automated recommendations.

For a user, the primary incentive with this bird's eye view is the ability to make better and informed decisions from the search results by visually correlating the search results to all the locations of interest. For example, in the case illustrated in FIG. 2, Amy and Tina, on individual occasions, visited the Pizza Hut on “^{˜}W 13th Avenue” on 5 different occasions in the last three months. This is, most likely, their favorite Pizza eat out restaurant. So, Tom, Tina and Amy might be willing to visit the “Pizza Hut” on “^{˜}W 13th Avenue” and will be able to connect to each other and proceed to make a reservation there.

### Explicit and Implicit Participants

In the example given above, a specific restaurant was recommended by the business listing service based, in part, on historical location-preference information of three people: Tom, Tina and Amy. The service may have determined that the relevant participants were Tom, Tina and Amy in any one of a variety of ways, some of which rely on explicit information and some of which rely on implicit information.

An explicit participant is a participant that has explicitly identified as a participant. For example, the business listing service may present Tom with a user interface that has controls for selecting which friends, for a larger social circle, will be participating in the meet-up for which the search is being performed. The service may assume that the requestor is also a participant, or may provide an additional control that allows the requestor to indicate whether or not the requestor is a participant.

The larger social circle that is presented to the user for selecting participants may, for example, be the user's first-degree friends in a particular social network. If there are too many first-degree friends to display simultaneously, then the service may initially present first-degree friends that the user has most frequently designated as participants in the past. Alternatively, the participant-selection interface may simply display the friends alphabetically, and/or provide the user a control for searching for participants by name.

Implicit participants are users that are treated as participants for the purpose of formulating a recommendation, but which have not been explicitly been identified as participants by the requestor. Implicit participants may be identified, for example, based on the context in which the recommendation is requested. For example, in one embodiment, the recommendation service may assume that all first-degree friends of the user in a given social circle are going to be participants. Based on this assumption, the location-preference information for all of those first-degree friends would be taken into account when selecting a recommendation, even though it is unlikely that all of those first-degree friends will be actual participants.

As another example, the automated recommendation service may detect that the user is in a chat room, or in an instant messaging conversation at the time the user submits the request for a recommendation. Based on this information, the automated recommendation service may assume that the other users in the chat room or instant messaging conversation are to be participants in the meet-up for which the requestor is requesting a recommendation. In this example, only the specific participants in the conversation, and not the entire set of first-degree friends of the requestor, are treated as participants for the purpose of formulating a recommendation.

A service may select the implicit participants based on a variety of factors. For example, a service may establish implicit participants to be all users that (a) are first-degree friends of the requestor, (b) are currently located within 5 miles of the requestor, and (b) have sent an email to the requestor within the last week. These are merely few examples of the virtually limitless number of factors a service may use for determining who to treat as implicit participants.

Who is treated as an implicit participant may also vary based on the type of event for which a search is being performed. For example, if the recommendation is for a location of a date, then the recommendation system may take treat second and third-degree friends within the social network as participants, since it is not uncommon for dates to occur with the friend of a friend. The recommendation system may determine that the recommendation request is for a date using a variety of techniques. For example, the recommendation system may determine that the recommendation is for a date if the requestor includes “date” in the search query, or if the search is for common date activities, such as “movie”.

As another example of selecting implicit participants based on the type of event, the requestor may belong to several specialized social circles, such as a motorcycle club, a ski club, and a boat club. In response to a request for a recommendation involving “motorcycles”, the recommendation system may include the members of the motorcycle club, but not the members of the ski or boat clubs.

### Weighted Preferences

As explained above, an automated recommendation system may treat users as participants based on a variety of factors. However, users that are treated as participants for one reason may be more or less likely to be actual participants than users that are treated as participants for another reason. For example, a user that is explicitly designated as a participant by the requestor is much more likely to be an actual participant than a user that is treated as a participant merely because he/she belongs to a social circle of the requestor.

According to one embodiment, the likelihood that a presumed participant is an actual participant is taken into account by applying different weights to the historic location-preference information of the presumed participants. For example, when making a recommendation, a service may apply a 1.0 weighting factor to the historic location-preference information of explicit participants, but only a 0.3 weighting factor to the historic location-preference information of users that qualify as participants merely because they belong to a social circle of the requestor. As another example, the weight given to participants may be based on how strongly tied those participants are to the requestor in a social network. Thus, a system may apply a 1.0 weighting factor to the location-preference information of first-degree friends of the requestor, and a 0.5 weighting factor to the location-preference information of second-degree friends of the requestor. These are merely some examples of how, when formulating a recommendation, a service may apply different weights to historical location-preference information based, at least in part, on how the corresponding users were determined to be participants.

### Explicit and Implicit Location Preferences

Similar to participants, location preferences may be explicit or implicit. An explicit location preference is where a user specifically indicates that the user likes a location. An explicit location preference may, for example, take the form of a review, where a user has given high ratings to a particular real-world location. As another example, an explicit location preference may take the form of a “check in”, where the user has explicitly indicated that the user was present at a particular place at a particular time.

Implicit location preferences are actions from which it may be inferred that a user has a preference for a particular location. For example, a user's frequent visits to the web-site of a particular restaurant may indicate that the user has a preference for that particular restaurant. As another example, a user of a photo-sharing service may have uploaded photos whose metadata indicates that the photos were taken at a particular park. From that metadata, it may be inferred that that user has a preference for that park. These are merely examples of the virtually limitless number of actions by which a user may implicitly indicate a location preference. The techniques described herein are not limited to any particular form of implicit-preference-indicating action.

### Location-Preference Information Sources

The sources from which a recommendation service may obtain location-preference information are as varied as the types of location-preference information the service uses. For example, a recommendation service may obtain explicit location-preference information from any number of services that allow users to “check-in” to real-world locations. As another example, a service may obtain explicit location-preference information from sites that feature user reviews of real-world businesses.

To gather implicit location-preference information, a toolbar installed on a user's browser may record which real-world business sites a user visits. As another example, the location metadata of photos of an online photo service may be correlated with the location information of business listings, to determine the businesses at which specific users have taken photos.

The recommendation service may be provided by the same party that serves as the source of the location-preference information, or may be a third party. Similarly, the recommendation service may be provided by the same party that manages the social circles of users, or may be provided by a third party. In the case where the recommendation service is separate from both the social network service and the location-preference information source, the recommendation service may query the social network service to obtain a list of presumed participants, and then query the location-preference information source to obtain historical location-preference information for those presumed participants.

### Presentation of Recommendations

FIG. 2 is merely one example of how recommendation results may be presented to a user. The actual form of presentation may vary from situation to situation, based on a variety of factors. For example, in the context of a map interface, the results may be presented in the form of differently-colored pins on the map, where the different colors correspond to different strengths of recommendation. In an alternative embodiment, gradations of the same color may be used to represent differing strengths of recommendation. Thus, dark red may represent the strongest recommendation while a lighter red may recommend a weaker recommendation.

A recommendation presentation system may place bounds on how many results can be assigned to each recommendation level. For example, the strongest recommendation group may be limited to three, which are shown with purple-colored pins. The next strongest recommendation group may be limited to five, which are shown with red-colored pins, etc.

Instead of, or in addition to, distinguishing recommendations based on color, the recommendations may be distinguished by accompanying text. For example, adjacent to some or all of the pins on a map, an explanation may be provided as to why that location is recommended. Thus, the explanation “2 visits by Tina” may be next to one pin, while the explanation “5 visits by Tina and Tom” may be next to another.

The presentation of recommendations may be affected by any number of other factors, in addition to the strength of recommendation derived from the historical location-preference information. For example, if discount coupons are available for certain locations in the search results, that fact may be reflected in the visual representation of that location. In the context of a map display, the pin for a location for which a discount is available may be a different color, or have some other distinguishing characteristic such a dot, a glowing aura, or a differently-shaped pin.

Instead of, or in addition to, providing results on a map interface, an automated recommendation service may provide textual search result listings, where the listings are ranked based, at least in part, on the historic location-preference information of the presumed participants. The listing may include textual explanations of why they are recommended (e.g. “5 visits by Tina and Tom”) as well as information about travel distance from the current location of each participant, a link to the business' web page, etc.

In one embodiment, the results of a recommendation request are not filtered based on historical location-preference information. Rather, all locations that satisfy the other selection criteria (e.g. search terms, maximum distance, etc.) are included in the displayed search results. However, the location-preference information is used to rank or otherwise visibly distinguish the recommended results from other results. FIG. 2 is an example of such an embodiment, where pins are shown for all Pizza Huts that satisfy the search term and distance criteria, but the recommended location is distinguished by having a different color pin, and explanatory text.

### Implicit Recommendation Requests

A request for a commendation may itself be implicit. For example, a recommendation system may determine, based on the contents of an instant messaging or email conversation, that the participants in the conversation may want to meet up for a particular purpose. For example, if the conversation includes several references to pizza restaurants, the recommendation system may determine that the participants in the conversation may be interested in a meet-up at a pizza restaurant. In response to determining that the contents of the conversation qualify as an implicit recommendation request, the recommendation system may formulate recommendations based on the historical location-preference information of the participants, and present the recommendation to one or more of the participants.

### Hardware Overview

According to one embodiment, the techniques described herein are implemented by one or more special-purpose computing devices. The special-purpose computing devices may include one or more general purpose hardware processors programmed to perform the techniques pursuant to program instructions in firmware, memory, other storage, or a combination.

The specific nature of the devices through which the techniques are implemented may vary from implementation to implementation, and the techniques are not limited to any particular type of device or technology. For example, a requestor may request a recommendation using any device with any type of input mechanism through which a human query may be expressed. The device may be connected to any type of communication channel capable of communicating the intent of the query to a recommendation service. The recommendation service may have any type of computing system capable of interpreting the intended query and processing the request by incorporating historic location data from the target participants. The recommendation service itself may be connected to any type of communication channel (which may or may not be the same communication channel used to communicate the query) capable of communicating the recommendation. Any type of device (which may or may not be the same device as was used to submit the request) with any type of output mechanism may be used to present the recommendation in a form that can be comprehended by a human as a set of one or more recommended locations. Thus, the techniques described herein are not necessarily implemented on currently-dominant forms of computer, may also be implemented on other forms of computing and communication (past and future).

Rather than exclusively using general purpose hardware, a special-purpose computing device that implements the techniques described herein may be hard-wired to perform the techniques, or may include digital electronic devices such as one or more application-specific integrated circuits (ASICs) or field programmable gate arrays (FPGAs) that are persistently programmed to perform the techniques. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

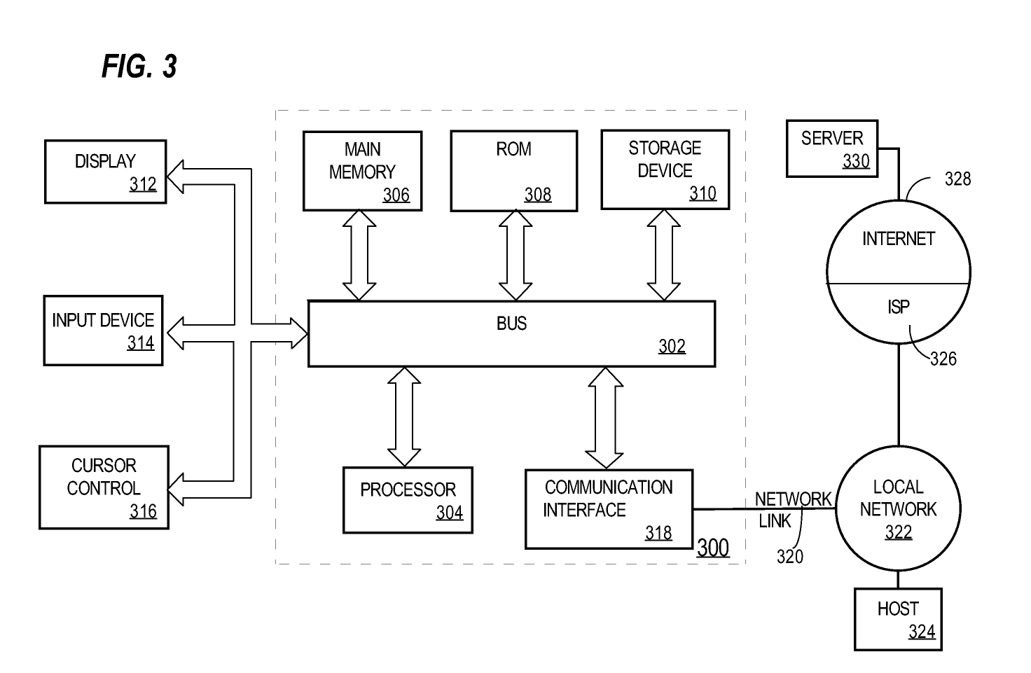

For example, FIG. 3 is a block diagram that illustrates a computer system 300 upon which an embodiment of the invention may be implemented. Computer system 300 includes a bus 302 or other communication mechanism for communicating information, and a hardware processor 304 coupled with bus 302 for processing information. Hardware processor 304 may be, for example, a general purpose microprocessor.

Computer system 300 also includes a main memory 306, such as a random access memory (RAM) or other dynamic storage device, coupled to bus 302 for storing information and instructions to be executed by processor 304. Main memory 306 also may be used for storing temporary variables or other intermediate information during execution of instructions to be executed by processor 304. Such instructions, when stored in non-transitory storage media accessible to processor 304, render computer system 300 into a special-purpose machine that is customized to perform the operations specified in the instructions.

Computer system 300 further includes a read only memory (ROM) 308 or other static storage device coupled to bus 302 for storing static information and instructions for processor 304. A storage device 310, such as a magnetic disk, optical disk, or solid-state drive is provided and coupled to bus 302 for storing information and instructions.

Computer system 300 may be coupled via bus 302 to a display 312, such as a cathode ray tube (CRT), for displaying information to a computer user. An input device 314, including alphanumeric and other keys, is coupled to bus 302 for communicating information and command selections to processor 304. Another type of user input device is cursor control 316, such as a mouse, a trackball, or cursor direction keys for communicating direction information and command selections to processor 304 and for controlling cursor movement on display 312. This input device typically has two degrees of freedom in two axes, a first axis (e.g., x) and a second axis (e.g., y), that allows the device to specify positions in a plane.

Computer system 300 may implement the techniques described herein using customized hard-wired logic, one or more ASICs or FPGAs, firmware and/or program logic which in combination with the computer system causes or programs computer system 300 to be a special-purpose machine. According to one embodiment, the techniques herein are performed by computer system 300 in response to processor 304 executing one or more sequences of one or more instructions contained in main memory 306. Such instructions may be read into main memory 306 from another storage medium, such as storage device 310. Execution of the sequences of instructions contained in main memory 306 causes processor 304 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 310. Volatile media includes dynamic memory, such as main memory 306. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 302. Transmission media can also take the form of acoustic or light waves, such as those generated during radio-wave and infra-red data communications.

Various forms of media may be involved in carrying one or more sequences of one or more instructions to processor 304 for execution. For example, the instructions may initially be carried on a magnetic disk or solid-state drive of a remote computer. The remote computer can load the instructions into its dynamic memory and send the instructions over a telephone line using a modem. A modem local to computer system 300 can receive the data on the telephone line and use an infra-red transmitter to convert the data to an infra-red signal. An infra-red detector can receive the data carried in the infra-red signal and appropriate circuitry can place the data on bus 302. Bus 302 carries the data to main memory 306, from which processor 304 retrieves and executes the instructions. The instructions received by main memory 306 may optionally be stored on storage device 310 either before or after execution by processor 304.

Computer system 300 also includes a communication interface 318 coupled to bus 302. Communication interface 318 provides a two-way data communication coupling to a network link 320 that is connected to a local network 322. For example, communication interface 318 may be an integrated services digital network (ISDN) card, cable modem, satellite modem, or a modem to provide a data communication connection to a corresponding type of telephone line. As another example, communication interface 318 may be a local area network (LAN) card to provide a data communication connection to a compatible LAN. Wireless links may also be implemented. In any such implementation, communication interface 318 sends and receives electrical, electromagnetic or optical signals that carry digital data streams representing various types of information.

Network link 320 typically provides data communication through one or more networks to other data devices. For example, network link 320 may provide a connection through local network 322 to a host computer 324 or to data equipment operated by an Internet Service Provider (ISP) 326. ISP 326 in turn provides data communication services through the world wide packet data communication network now commonly referred to as the “Internet” 328. Local network 322 and Internet 328 both use electrical, electromagnetic or optical signals that carry digital data streams. The signals through the various networks and the signals on network link 320 and through communication interface 318, which carry the digital data to and from computer system 300, are example forms of transmission media.

Computer system 300 can send messages and receive data, including program code, through the network(s), network link 320 and communication interface 318. In the Internet example, a server 330 might transmit a requested code for an application program through Internet 328, ISP 326, local network 322 and communication interface 318.

The received code may be executed by processor 304 as it is received, and/or stored in storage device 310, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
identifying one or more participants in a social networking service that are friends in the social networking service with a particular user of the social networking service;
retrieving historical geographic location-preference information for the one or more participants in the social networking service that are friends in the social networking service with the particular user of the social networking service, wherein the historic geographic location-preference information for the one or more participants in the social networking service that are friends in the social networking service with the particular user of the social networking service includes information about geographic locations for which the one or more participants have submitted online reviews;
automatically determining one or more geographic locations to recommend to the particular user based, at least in part, on the historic geographic location-preference information for the one or more participants in the social networking service that are friends in the social networking service with the particular user of the social networking service includes information about geographic locations for which the one or more participants have submitted online reviews; and
causing display of data that recommends the one or more geographic locations to the particular user;
wherein the method is performed by one or more computing devices.

2. The method of claim 1, wherein identifying one or more participants in a social networking service that are friends in the social networking service with a particular user of the social networking service includes identifying a particular participant in the social networking service that is a friend in the social networking service with the particular user of the social networking service and that is currently in an online chat room or involved in an instant messaging conversation with the particular user.

3. The method of claim 1, wherein identifying one or more participants in a social networking service that are friends in the social networking service with a particular user of the social networking service includes identifying a particular participant in the social networking service that is a first degree friend in the social networking service with the particular user of the social networking service and that is currently within a specified distance of the particular user.

4. The method of claim 1, wherein identifying one or more participants in a social networking service that are friends in the social networking service with a particular user of the social networking service includes identifying a particular participant in the social networking service that is a friend in the social networking service with the particular user of the social networking service and that has been designated as a participant by the particular user.

5. The method of claim 1, wherein the historical geographic location-preference information for the one or more participants in the social networking service that are friends in the social networking service with the particular user of the social networking service includes one or more of information that specifies one or more geographic locations that the one or more participants in the social networking service have all visited or information about where the one or more participants in the social networking service have previously checked in.

6. The method of claim 1, wherein the one or more participants include at least one implicit participant and one explicit participant.

7. The method of claim 1, wherein the one or more participants in the social networking service that are friends in the social networking service with the particular user of the social networking service include:
a first participant whose historical geographic location preferences are given a first weight when determining the one or more geographic locations to recommend; and
a second participant whose historical geographic location preferences are given a second weight when determining the one or more geographic locations to recommend;
wherein the first weight is different than the second weight;
wherein the first and second weights are used based, at least in part, on how the first and second participants qualified as participants.

8. The method of claim 7, wherein the first and second weights are determined based, at least in part, on how strongly the particular user is connected to the first and second participants in the social networking service.

9. The method of claim 1, wherein the historic geographic location-preference information includes implicit geographic location-preference information.

10. The method of claim 9, wherein the implicit geographic location-preference information includes one or more of information about web sites visited by the one or more participants in the social networking service or information about where the one or more participants have taken photos.

11. The method of claim 1, wherein:
automatically determining one or more geographic locations to recommend is performed in response to the particular user requesting a recommendation for a particular type of event, and
the one or more participants in the social networking service that are friends in the social networking service with the particular user of the social networking service are selected as participants based, at least in part, on the particular type of event.

12. One or more non-transitory computer-readable media storing instructions which, when
processed by one or more computing devices, cause:
identifying one or more participants in a social networking service that are friends in the social networking service with a particular user of the social networking service;
retrieving historical geographic location-preference information for the one or more participants in the social networking service that are friends in the social networking service with the particular user of the social networking service, wherein the historic geographic location-preference information for the one or more participants in the social networking service that are friends in the social networking service with the particular user of the social networking service includes information about geographic locations for which the one or more participants have submitted online reviews;
automatically determining one or more geographic locations to recommend to the particular user based, at least in part, on the historic geographic location-preference information for the one or more participants in the social networking service that are friends in the social networking service with the particular user of the social networking service includes information about geographic locations for which the one or more participants have submitted online reviews; and
causing display of data that recommends the one or more geographic locations to the particular user.

13. The one or more non-transitory computer-readable media of claim 12, wherein identifying one or more participants in a social networking service that are friends in the social networking service with a particular user of the social networking service includes identifying a particular participant in the social networking service that is a friend in the social networking service with the particular user of the social networking service and that is currently in an online chat room or involved in an instant messaging conversation with the particular user.

14. The one or more non-transitory computer-readable media of claim 12, wherein identifying one or more participants in a social networking service that are friends in the social networking service with a particular user of the social networking service includes identifying a particular participant in the social networking service that is a first degree friend in the social networking service with the particular user of the social networking service and that is currently within a specified distance of the particular user.

15. The one or more non-transitory computer-readable media of claim 12, wherein identifying one or more participants in a social networking service that are friends in the social networking service with a particular user of the social networking service includes identifying a particular participant in the social networking service that is a friend in the social networking service with the particular user of the social networking service and that has been designated as a participant by the particular user.

16. The one or more non-transitory computer-readable media of claim 12, wherein the historical geographic location-preference information for the one or more participants in the social networking service that are friends in the social networking service with the particular user of the social networking service includes one or more of information that specifies one or more geographic locations that the one or more participants in the social networking service have all visited or information about where the one or more participants in the social networking service have previously checked in.

17. The one or more non-transitory computer-readable media of claim 12, wherein the one or more participants in the social networking service that are friends in the social networking service with the particular user of the social networking service include:
a first participant whose historical geographic location preferences are given a first weight when determining the one or more geographic locations to recommend; and
a second participant whose historical geographic location preferences are given a second weight when determining the one or more geographic locations to recommend;
wherein the first weight is different than the second weight;
wherein the first and second weights are used based, at least in part, on how the first and second participants qualified as participants.

18. The one or more non-transitory computer-readable media of claim 17, wherein the first and second weights are determined based, at least in part, on how strongly the particular user is connected to the first and second participants in the social networking service.

19. A system comprising:
one or more computing devices configured to provide an automated recommendation service by:
identifying one or more participants in a social networking service that are friends in the social networking service with a particular user of the social networking service;
retrieving historical geographic location-preference information for the one or more participants in the social networking service that are friends in the social networking service with the particular user of the social networking service, wherein the historic geographic location-preference information for the one or more participants in the social networking service that are friends in the social networking service with the particular user of the social networking service includes information about geographic locations for which the one or more participants have submitted online reviews;
automatically determining one or more geographic locations to recommend to the particular user based, at least in part, on the historic geographic location-preference information for the one or more participants in the social networking service that are friends in the social networking service with the particular user of the social networking service includes information about geographic locations for which the one or more participants have submitted online reviews; and
causing display of data that recommends the one or more geographic locations to the particular user.

20. The system of claim 19 wherein:
automatically determining one or more geographic locations includes filtering search results based on, at least in part, on current locations of at least two participants from the one or more participants in the social networking service, to produce a set of filtered search results; and
causing presentation of a display includes, on a map display, visually distinguishing the filtered search results from each other based, at least in part, on the historic geographic location-preference information.
